(19) United States
(12) Patent Application Publication
(10) Pub. No.: US 2013/0024111 A1
(43) Pub. Date: Jan. 24, 2013

(54) SYSTEM AND METHOD TO GRAPHICALLY GUIDE VISITORS USING AN INTEGRATED READER AND ACCESS CONTROL BASED ON SHORTEST PATH

(71) Applicants: Abarna Shanmugasundaram, Chennai (IN); Santhanakrishnan Ponnambalam, Hosur (IN)

(72) Inventors: Abarna Shanmugasundaram, Chennai (IN); Santhanakrishnan Ponnambalam, Hosur (IN)

(73) Assignee: Honeywell International Inc., Morristown, NJ (US)

(21) Appl. No.: 13/184,946

(22) Filed: Jul. 18, 2011

(51) Int. Cl. G01C 21/00

(52) U.S. Cl. 701/434; 701/435

(57) ABSTRACT

A method for graphically guiding visitors of a building to a shortest path using an integrated reader and access control is provided. The method includes receiving a user's identification code, receiving a user's destination location, uploading a current floor plan of a location, determining non-accessible areas in the location based on the user's identification code, and computing a shortest path from a present location to the destination location, wherein the shortest path circumvents the non-accessible areas.

### FIELD OF INVENTION

The present invention relates generally to visitor management systems and access control. More particularly, the present invention relates to systems and methods for graphically guiding visitors of a building to a shortest path using an integrated reader and access control.

### BACKGROUND

In many large buildings and facilities, for example, airports and corporate or manufacturing facilities, security is important. Thus, when a guest visits the building, he is often escorted to his host, and his host is responsible for guiding the guest throughout the building during the guest's stay. However, when many guests frequently visit a particular building, escorting guests to their hosts can be tedious and time consuming.

To alleviate this burden, many large buildings employ visitor management systems to handle guests' check in and check out process. The guest management system can be integrated with a physical access control system, and the access control system can provide a guest with a temporary access card or badge. A temporary access card can provide limited access levels to the guest for the period of the guest's visit. For example, a guest can swipe his temporary access card at access points or readers in the building to traverse the building and reach his host and/or destination.

Because guests are often unfamiliar with a large building or enterprise, it is common for guests to get lost. When lost, a guest must consult a static floor plan or map in the building and/or ask for assistance from others. This approach can be tiresome and time consuming for a guest because a static floor plan does not indicate the guest's position in the building. Furthermore, a static floor plan does not factor in the guest's access levels when displaying possible paths from one position to another.

There is thus a continuing, ongoing need for systems and methods for graphically guiding visitors of a building to a shortest path using an integrated reader and access control. Preferably such systems and methods are easily usable, visually appealing, and dynamically configurable while taking into account building security.

### BRIEF DESCRIPTION OF THE DRAWINGS

FIG. 1 is a flow diagram of a method of determining a shortest path in accordance with the present invention;

FIG. 2 is a block diagram of a system for carrying out the method of FIG. 1 in accordance with the present invention;

FIG. 3 is a bitmap image of a floor plan in accordance with the present invention;

FIG. 4 is a pixel block image of the bitmap image of FIG. 3 in accordance with the present invention;

FIG. 5 is a pixel matrix of the pixel block image of FIG. 4 in accordance with the present invention;

FIG. 6 is a compacted matrix of the pixel matrix of FIG. 5 in accordance with the present invention;

FIG. 7A is a first computed path using the compacted matrix of FIG. 6 in accordance with the present invention; and

FIG. 7B is a second computed path using the compacted matrix of FIG. 6 in accordance with the present invention.

### DESCRIPTION OF THE PREFERRED EMBODIMENTS

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments of the present invention include systems and methods for graphically guiding visitors of a building to a shortest path using an integrated reader and access control. Preferably such systems and methods are easily usable, visually appealing, and dynamically configurable taking into account building security.

In accordance with the present invention, an improved access control device can be placed at each access point in an access control system employed in a building. When a guest swipes his access card, the improved access control device can dynamically compute and graphically display a shortest path from the access control device to the guest's destination. The destination could be another access control device or a location of a host in the building.

For example, when a guest arrives at a building, he can be provided with a temporary access card. The temporary access card can be programmed with the guest's unique host destination code or address. In some embodiments, the host destination code can be a value configured by an operator of the access control system that is integrated with a visitor management system.

An access control device can be placed at each access point in the building. In embodiments of the present invention, each access control device can contain the latest floor plan for the building. The floor plan can be uploaded through associated access system host software. For example, the latest floor plan can be uploaded from an associated control unit.

When an access card is presented to an access control device, the device can extract the unique card number and the host destination code programmed into the card. The access control device can then validate the card and use the host destination code to compute a shortest path to the host destination. In embodiments of the present invention, the access control device can factor in access levels available to the guest when computing the shortest path.

In accordance with the present invention, a shortest path can be computed using a floor plan of a building and an access level of a guest. For example, after obtaining the access level of a guest, systems and methods of the present invention can alter the floor plan of the building to create a temporary floor plan. The temporary floor plan can include obstacles that correlate to access points for which the guest does not have access.

Systems and methods of the present invention can convert the temporary floor plan into a pixel matrix of 0's and 1's. In embodiments, a 1 can correspond to a path available to the guest, and a 0 can correspond to an obstacle, that is, a path that is not available to the guest. The pixel matrix can then be compacted into a matrix with smaller dimensions. For example, a block of pixels in the pixel matrix with the same value can be mapped into a single pixel in the compacted matrix with that value.

Using the compacted matrix, systems and methods in accordance with the present invention can compute a shortest path between two blocks of pixels. For example, all possible paths between two blocks of pixels can be computed by propagating through the four axial neighbors of each pixel from the source location to the destination location. If a given pixel location in the compacted matrix can be represented by (5,5), then that location's four axial neighbors are (4,5), (5,6), (6,5), and (5,4).

When all of the possible paths are computed, the shortest path can be selected. In embodiments, if two or more possible paths have the same distance, then the path with the lowest number of turns can be considered the shortest path.

In embodiments of the present invention, when the shortest path is computed and determined, an access control device can graphically display the route map. In some embodiments, the access control device can also print the route map showing the shortest path.

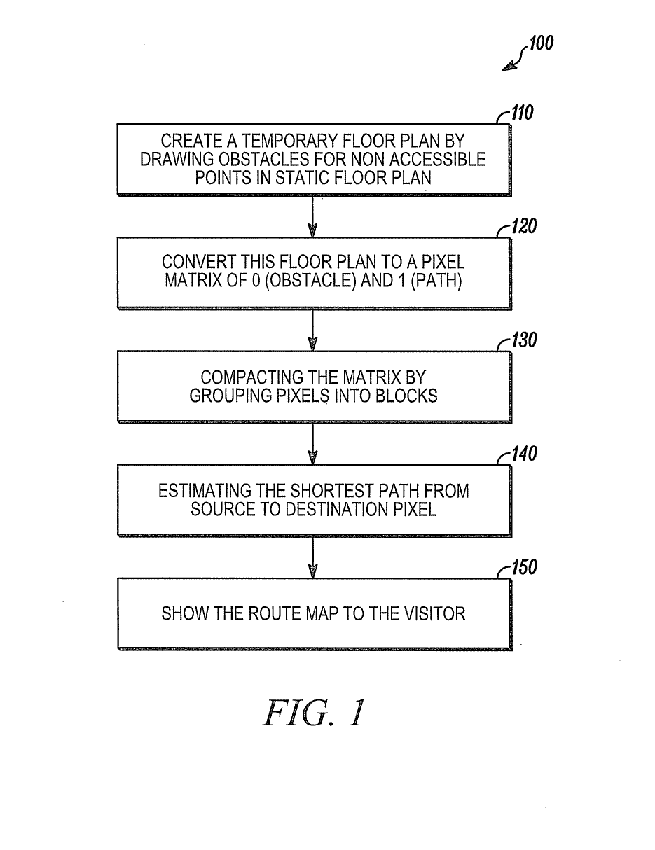

FIG. 1 is a flow diagram of a method 100 of determining a shortest path in accordance with the present invention. As seen in FIG. 1, a temporary floor plan can be created as in 110. The temporary floor plan can include obstacles that correspond to areas in the floor plan that are not accessible to a user.

The temporary floor plan can be converted to a pixel matrix as in 120. The pixel matrix can represent an obstacle with a 0 and a possible path with a 1. Then, the pixel matrix can be compacted as in 130. For example, blocks of pixels in the pixel matrix that have the same value can be grouped together in the compacted matrix.

The shortest path from a source pixel in the compacted matrix to a destination pixel in the compacted matrix can be estimated as in 140. For example, possible paths between two blocks of pixels can be computed by propagating through the four axial neighbors of each pixel from the source location to the destination location. Then, a route map showing the shortest path can be displayed to a user as in 150.

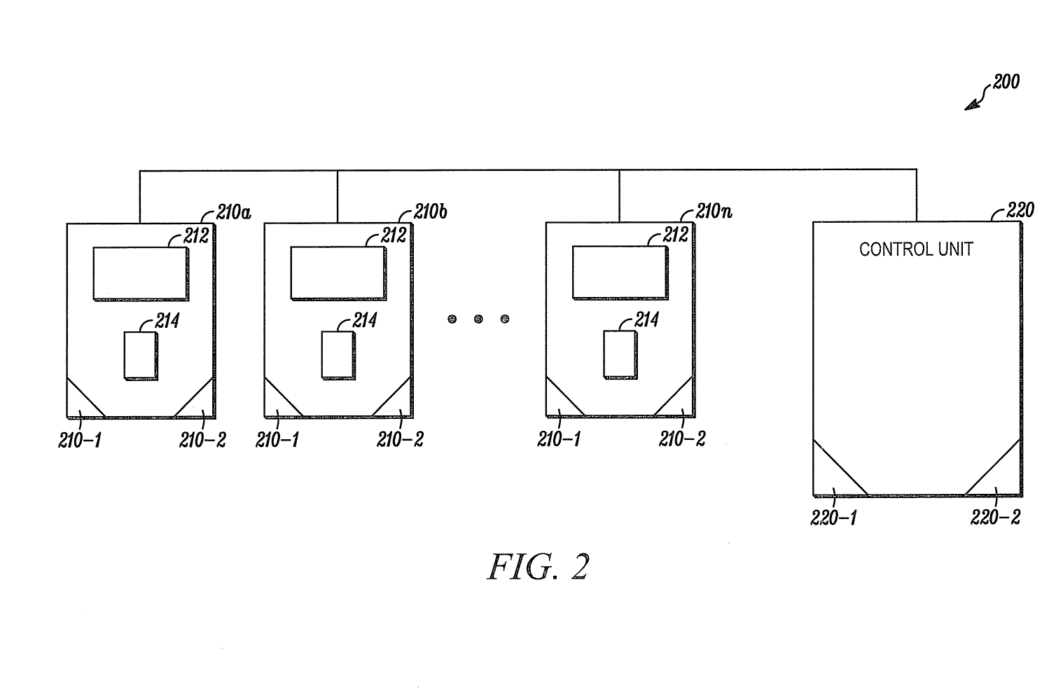

The method of FIG. 1 and others in accordance with the present invention can be implemented with the system 200 shown in FIG. 2. As seen in FIG. 2, a plurality of control access devices 210a, 210b, . . . 210n in a building can be in wired or wireless communication with a control unit 220. The control unit 220 can be implemented with one or more programmable processors 220-1 and executable control software 220-2 as would be understood by those of ordinary skill in the art. The executable control software 220-2 can be stored on a transitory or non-transitory local computer readable medium.

Each of the plurality of control access devices 210a, 210b, . . . 210n can include one or more programmable processors 210-1 and executable control software 210-2. Each device 210a, 210b, . . . 210n can also include an output display 212 and one or more input devices 214. The output display 212 can include a multi-dimensional graphical user interface. The input devices 214 can include a keypad and/or a scanner for reading an access card.

In embodiments of the present invention, when an access card is presented to the input device 214 of a control access device 210, the display 214 of the device 210 can present a graphical display of a shortest path to the user. In some embodiments, the device 210 can be interactive.

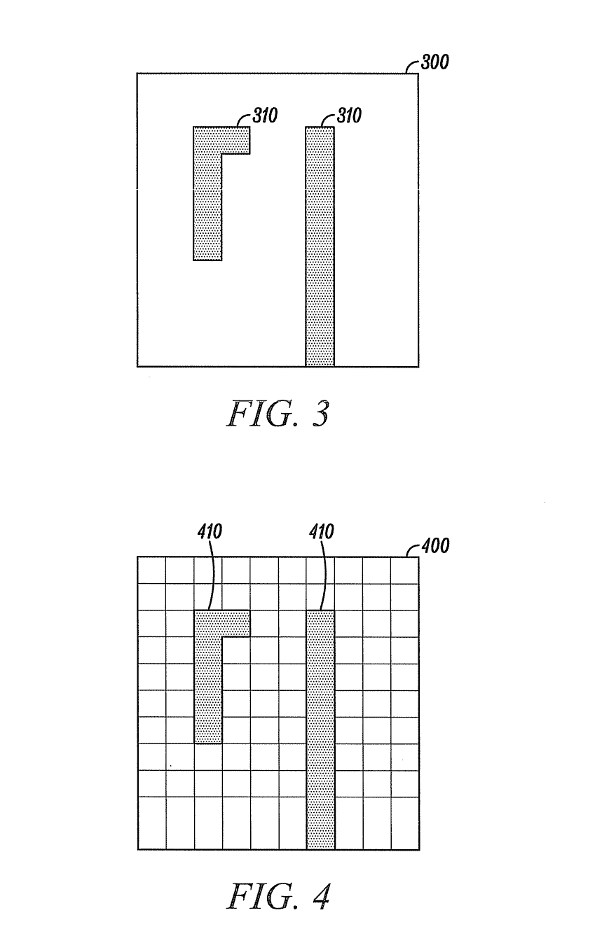

As explained above, to compute a shortest path, systems and methods of the present invention can create a temporary floor plan, a pixel matrix, and a compacted matrix. A temporary floor plan can be a bitmap image of a floor plan of a building, for example, the bitmap image 300 of FIG. 3. As seen in FIG. 3, if the bitmap image 300 is black and white, then obstacles for non-accessible areas can be displayed as dark blocks 310. When the bitmap image is in color, white can represent possible paths, and all colors can represent obstacles.

The bitmap image 300 of FIG. 3 can be converted into a pixel block image. For example, FIG. 4 is a pixel block image 400 of the bitmap image 300 of FIG. 3. As can be seen in FIG. 4, the pixel block image 400 splits the bitmap image 300 into pixel blocks. Each pixel block can represent information of a small area on the floor plan.

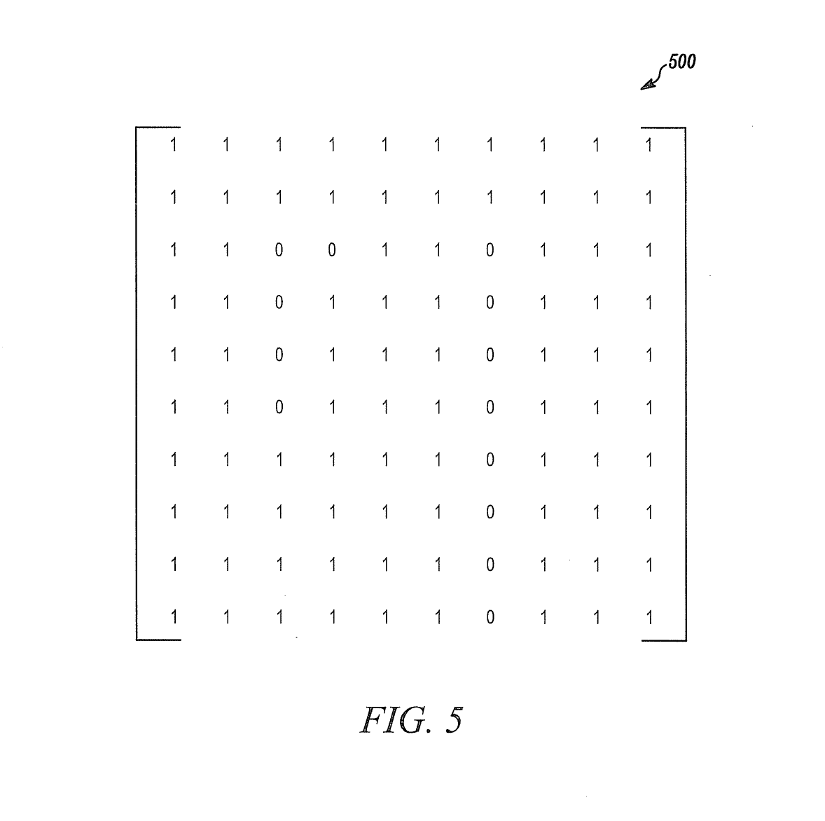

The pixel block image 400 of FIG. 4 can be converted into a pixel matrix. For example, FIG. 5 is a pixel matrix 500 of the pixel block image 400 of FIG. 4. As can be seen in FIG. 5, the pixel matrix 500 can be a series of 1's and 0's. A 1 can represent a possible path, and a 0 can represent an obstacle.

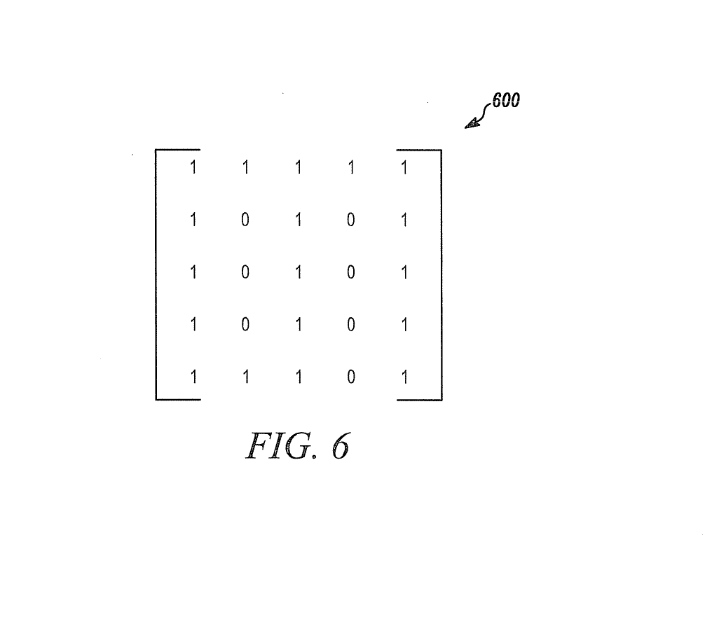

The pixel matrix 500 of FIG. 5 can be converted into a compacted matrix. For example, FIG. 6 is a compacted matrix 600 of the pixel matrix 500 of FIG. 5. In some embodiments, the compacted matrix 600 can be created by grouping blocks of pixels in the pixel matrix 500 that have the same value. In other embodiments, the compacted matrix 600 can be created by grouping X number of pixels in pixel matrix 500, regardless of pixel value.

For example, the compacted matrix 600 can be created by grouping every two pixels in the pixel matrix 500. When a small number of pixels, such as two, are grouped, the accuracy of computed paths will not be affected.

When the pixel matrix 500 has dimensions M×N and when every X number of pixels in the pixel matrix 500 are grouped, the dimensions of the compacted matrix will be (M/X)×(N/X). In embodiments of the present invention, if any pixel in a block to be grouped together is an obstacle, the corresponding pixel in the compacted matrix 600 will be set to 0.

FIG. 6 is a compacted matrix 600 of the pixel matrix 500 when every two pixels have been grouped together. Thus, the pixel matrix 500 is 10×10, and the pixel matrix 600 is (10/2)×(10/2), or 5×5.

Embodiments of the present invention do not compute diagonal traversing paths. Rather, embodiments of the present invention compute straight, that is, axial, paths. Therefore, when computing possible, paths, systems and methods of the present invention consider the four axial neighbors of each location.

When computing possible paths, a position index of a pixel location can be stored in a one-dimensional array, A. If there is a possible path in any of the pixel's four axial neighbors, the possible path can be appended to the one-dimensional array, A. Possible paths in a pixel location's four axial neighbors can be computed and appended to the one-dimensional array, A, until a destination location is reached. In this manner, the completed one-dimensional array, A, can provide possible paths from a source location to the destination location.

For example, a source position of the compacted matrix 600 can be stored in the one-dimensional array, A, as an element, E, where E=(m/2)×(1+n/2). Thus, where a source position (x,y) is (1,2) in the matrix 600, the corresponding element, E in the one-dimensional array, A, can be E=(1/2)×(1+2/2)=½×2=1.

Similarly, an index position can be determined from the one-dimensional array, A, where the index position is (E/m, E % m). Thus, where E=1, the index position is (1/m, 1% m).

In accordance with the present invention, the first possible path can be stored in the one-dimensional array, A. Other alternate paths can be computed using a temporary one-dimensional array, B. If the length of the path in B is smaller than the length of the path in A, then the path in A can be replaced with the path in B. This can be repeated for all possible paths so that, when completed, the one-dimensional array, A, will contain the shortest path. In embodiments of the present invention, when two paths have the same length, the path with the lowest number of turns can be considered the shortest path.

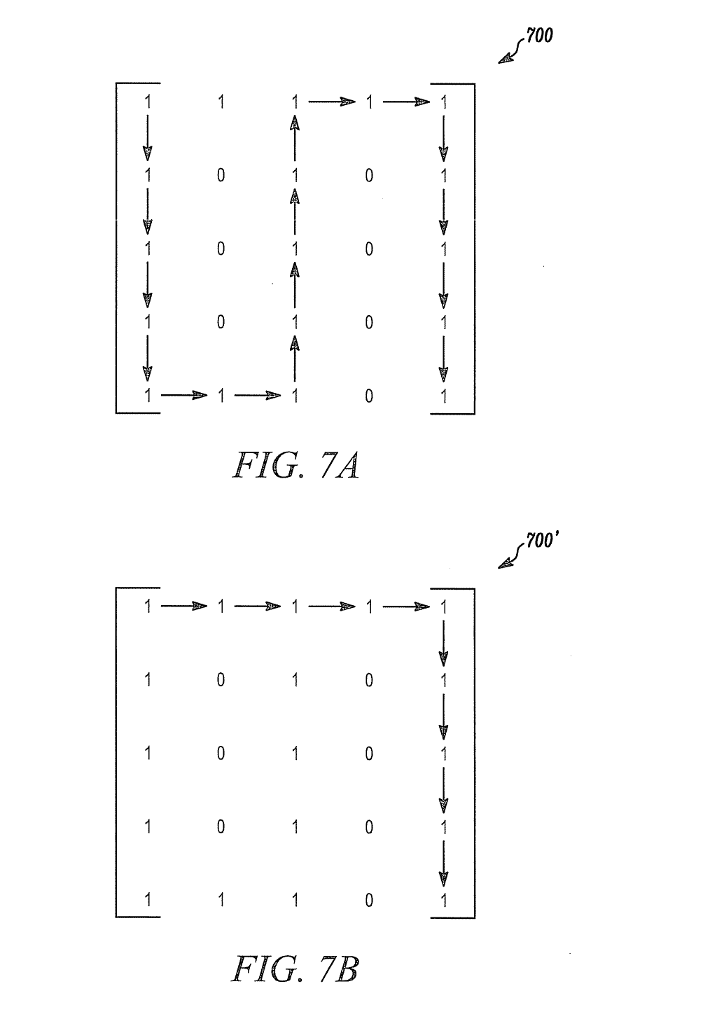

FIG. 7A is a first computed path 700 using the compacted matrix of FIG. 6, and FIG. 7B is a second computed path 700′ using the compacted matrix of FIG. 6. For exemplary purposes, position (0,0) can be considered the source location, and position (4,4) can be considered the destination location.

Location (0,0) has two axial neighbors: (1,0) and (0,1). FIG. 7A shows the path 700 through (1,0), and FIG. 7B shows the path 700′ through (0,1). The path 700 through (1,0) shown in FIG. 7A is longer than the path 700′ through (0,1) shown in FIG. 7B. Therefore, the path 700′ through (0,1) in FIG. 7B can be considered the shortest path. As seen in FIG. 7B, the shortest path 700′ traverses through the following locations: (0,0), (0,1), (0,2), (0,3), (0,4), (1,4), (2,4), (3,4), and (4,4).

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

From the foregoing, it will be observed that numerous variations and modifications may be effected without departing from the spirit and scope of the invention. It is to be understood that no limitation with respect to the specific system or method illustrated herein is intended or should be inferred. It is, of course, intended to cover by the appended claims all such modifications as fall within the spirit and scope of the claims.

What is claimed is:

1. A method comprising:
receiving a user's identification code;
receiving a user's destination location;
uploading a current floor plan of a location;
determining non-accessible areas in the location based on the user's identification code; and
computing a shortest path from a present location to the destination location, wherein the shortest path circumvents the non-accessible areas.

2. The method of claim 1 further comprising validating the user's identification code.

3. The method of claim 1 wherein computing the shortest path from the present location to the destination location includes:
creating a temporary floor plan from the current floor plan, the temporary floor plan including obstacles that correlate to the non-accessible areas;
converting the temporary floor plan into a pixel matrix; and
computing a shortest path from a first pixel to a second pixel in the pixel matrix, the first pixel representing the present location and the second pixel representing the destination location.

4. The method of claim 3 wherein each entry in the pixel matrix is either a 1 or a 0, and wherein 1 represents an available path and 0 represents an obstacle.

5. The method of claim 3 further comprising converting the pixel matrix into a compacted matrix.

6. The method of claim 5 wherein converting the pixel matrix into the compacted matrix includes grouping blocks of pixels in the pixel matrix that have the same value.

7. The method of claim 5 wherein converting the pixel matrix into the compacted matrix includes grouping X number of pixels in the pixel matrix, regardless of value.

8. The method of claim 7 further comprising identifying a pixel as an obstacle in the compacted matrix when any of an underlying group of pixels in the pixel matrix identifies an obstacle.

9. The method of claim 3 wherein computing the shortest path from the first pixel to the second pixel includes propagating through four axial neighbors of each available pixel from the first pixel to the second pixel.

10. The method of claim 3 wherein computing the shortest path from the first pixel to the second pixel includes computing all possible paths from the first pixel to the second pixel and selecting the shortest path from all of the possible paths.

11. The method of claim 1 further comprising graphically displaying the shortest path on a map.

12. A device comprising:
an input device for receiving a user's identification code and a user's destination location;
a programmable processor and executable control software for accessing a current floor plan of a location, determining non-accessible areas in the location based on the user's identification code, and computing a shortest path from a location of the device to the destination location such that the shortest path circumvents cross the non-accessible areas; and
an output display for graphically displaying the shortest path on a map.

13. The device of claim 12 wherein the output display includes a multi-dimensional graphical user interface.

14. The device of claim 13 wherein the multi-dimensional graphical user interface is interactive.

15. The device of claim 12 wherein the input device includes a scanner for reading an access card.

16. The device of claim 12 wherein, to compute the shortest path from the present location to the destination location, the programmable processor and executable control software create a temporary floor plan from the current floor plan, the temporary floor plan including obstacles that correlate to the non-accessible areas, convert the temporary floor plan into a pixel matrix, and compute a shortest path from a first pixel to a second pixel in the pixel matrix, the first pixel representing the present location and the second pixel representing the destination location.

17. The device of claim 16 wherein, to compute the shortest path from the first pixel to the second pixel, the programmable processor and executable control software propagate through four axial neighbors of each available pixel from the first pixel to the second pixel.

18. An apparatus comprising:
circuitry for identifying a user's identification code;
circuitry for identifying a user's destination location;
circuitry for accessing a current floor plan of a location;
circuitry for determining non-accessible areas in the location based on the user's identification code; and
circuitry for computing a shortest path from a present location to the destination location, wherein the shortest path circumvents the non-accessible areas.

19. The apparatus of claim 18 wherein the circuitry for computing the shortest path from the present location to the destination location includes:
circuitry for creating a temporary floor plan from the current floor plan, the temporary floor plan including obstacles that correlate to the non-accessible areas;
circuitry for converting the temporary floor plan into a pixel matrix; and
circuitry computing a shortest path from a first pixel to a second pixel in the pixel matrix, the first pixel representing the present location and the second pixel representing the destination location.

20. The apparatus of claim 19 wherein the circuitry for computing the shortest path from the first pixel to the second pixel includes circuitry for propagating through four axial neighbors of each available pixel from the first pixel to the second pixel.
